(19) United States
(12) Patent Application Publication
(10) Pub. No.: US 2005/0246429 A1
(43) Pub. Date: Nov. 3, 2005

(54) Information services by means of a telecommunications web site

(75) Inventor: Matthias Greve, Karlsruhe (DE)

Correspondence Address: Davidson Davidson & Kappel, 485 Seventh Avenue, 14th Floor, New York, NY, 10018, US

(73) Assignee: WEB,DE AG, KARLSRUHE (DE)

(21) Appl. No.: 10/513,111

(22) PCT Filed: Apr. 30, 2003
(86) PCT No.: PCT/EP03/04538

§ 371 Date: Oct. 29, 2004

(30) Foreign Application Priority Data
Apr. 30, 2002 (EP) 02009777.0
Jul. 19, 2002 (EP) 02016141.0
Jul. 23, 2002 (US) 10/201,445
Jan. 29, 2003 (US) 10/354709
Mar. 13, 2003 (EP) 03005694.9
Mar. 25, 2003 (US) 60457851

(51) Int. Cl. G06F 15/16

(52) U.S. Cl. 709/219

(57) ABSTRACT

A method for providing an information service, comprising the steps of communicating, from a user via a request communications link to at least one information service provider (ISP), information service indication data indicating at least one information service requested by the user, and providing the at least one indicated information service from at least one of the at least one information service provider (ISP) to the user.

### FIELD OF THE INVENTION

In general, the present invention relates to information services and, in particular, information service provided by means of a telecommunications web site.

### BACKGROUND OF THE INVENTION

Information is a key issue in communications technologies. Therefore, more and more user desire more and more information which is provided by more and more specialized information providers and companies purchasing products and services.

In particular, the Internet offers a wide range of information of any kind and from different sources. As a result, users are often not able to cope with the amount of information supply. Further, skills and knowledge is required for users to have requested information provided or to access desired information via the Internet.

Further, today's information sources are provided in a separated manner such that users have to contact different information sources in different communications environments to finally get requested and desired information. For example, to obtain specific information can require to contact both telephone based information services and Internet information providers. In consequence, users often do not utilize all available information sources due to the associated effort. An integration of information sources of different and separated communications environments does not exist.

Moreover, existing approaches to provide information requested by a user are rather limited as regards supply of information to the requesting user. For example, information requested via the Internet by means of a personal computer will be supplied to the requesting personal computer. Comparable thereto, information from a telephone information service is communicated to the telephone used for requesting that information. In that regard, integration does also not exist.

### OBJECT OF THE INVENTION

In general, the object underlying the present invention is to overcome the above problems of existing approaches to provide information. In particular, the present invention should provide solutions to provide information in an enhanced and more user friendly way. Moreover, the present invention should allow for a more reliable supply of information such that information sources of different communications environments will be considered in view of information requested by a user.

### SHORT DESCRIPTION OF THE INVENTION

The above object of the present invention is solved by a method for providing an information service to a user comprising the steps of communicating, from a user via a request communications link to at least one information service provider, information service indication data indicating at least one information service requested by the user, and providing the at least one indicated information service from at least one of the at least one information service provider via a information service communications link to the user.

The information service indication data can be in form of analog or digital data obtained from or provided by the user by means, e.g., operating a key pad of a telecommunications device, such as a telephone or computer, sending voice data for example by inputting voice messages into the handset or headset of a telephone or computer, sending a facsimile. Depending from its nature, it might be necessary to analyzed, scanned or the like the information service indication data on the receiving side to obtain the content thereof, in particular, in case of information service indication data in form of voice data or text data.

Included in the information service indication data or separate therefrom, identification data for at least one of identification and authentification of the user can be communicated. The identification data include at least one of a number code, an alphanumerical code, data representative of a communications link unit via which the information service communications link is to be established, data obtained from voice recognition, data being indicative of the user.

Preferably, the information service indication data are communicated from a first end user unit via the request communications link, while it is possible that the at least one indicated information service is communicated via the information service communications link to the first end user unit or to a second end user unit.

According to a preferred embodiment, the information service indication data are communicated from the user to a telecommunications web site and therefrom to the at least one information service provider. Further, it is preferred that the telecommunications web site is associated to the user. To initiate the method according to the present invention, it is possible to activate a portion of a graphical user interface provided by the telecommunications web site.

When incorporating a telecommunications web site into the method according to the present invention, it is possible that a first end user unit used for communicating the information service indication data is associated to a first entity. In case, the information service is provided to a second end user unit, the second end user unit can be associated to the first entity or a second entity.

Further, the at least one information service communications link can be established under control of the telecommunications web site between the at least one of the at least one information service provider and the first or the second end user unit.

In case, for example, the information service indication data is not sufficient for the telecommunications web site to identify at least one particular information service provider for the requested information service, the telecommunications web site can select the at least one information service provider on the basis of the information service indication data.

In order to enable the first end user unit to at least partially participate in the selection of information service providers, the telecommunications web site can communicate to the user data specifying at least one information service in line with information service indication data. In case the user wants to actually select an information service provider, selection data indicating an selection of an information service from the at least one specified information service are communicated to the telecommunications web site.

Preferably, the information service communications link is established in dependence of the information service indicating data. This allows employing an information service communications link adapted or configured or predefined for the requested information service. Further, in this manner, the first end user unit can specify which communications link(s) will be used as information service communications link. Such specifying data can be included in the information service indication data. It is contemplated that the information service communications link is established in dependence of at least one of second end user unit characterizing data communicated from the first end user unit, second end user unit characterizing data stored in an memory associated to the information service provider or telecommunications web site, communications link characterizing data communicated from the first end user unit, operability of the first or the second end user unit, technical properties of the first or the second end user unit, and nature of the at least one requested information service.

For establishing the information service communications link, it is contemplated to use a communications link via the telecommunications web site and/or via a communications link unit.

In case of an information service communications link via a communications link unit, it is possible to establish, at least partially under control of the telecommunications web site, a communications link from the communications link unit to the information service provider and a communications link from the communications link unit to user, e.g. the first or the second end user unit. By linking these communications links, also at least partially under control of the telecommunications web site, the information service communications link can be formed.

For obtaining the at least one requested information service, the user can access the at least one information service provider via the information service communications link and/or the at least one information service can be communicated or provided from a respective one of the at least one information service provider to the user via the information service communications link.

For billing of costs related to the information service communications link and/or cost related to an access to the at least one information service provider, it is possible to account such costs at least partially under control of the telecommunications web site to the end user unit.

In a preferred embodiment, at least parts of information, e.g. in form of data, provided by the at least one indicated information service to the user are stored by means of the telecommunications web site.

Moreover, in view of the above object, the present invention provides an end user unit being adapted to be operated according to the method set forth above, a telecommunications web site for providing at least one information service to a user, a software program product for providing at least one information service to a user, a communications environment and a graphical user interface, each thereof being defined in the accompanying claims.

### SHORT DESCRIPTION OF THE FIGURES

In the following description of preferred embodiments of the present invention, it is referred to the accompanying drawings wherein:

FIGS. 1a and 1b illustrate embodiments according to the present invention,

FIG. 2 illustrates an embodiment according to the present invention including a telecommunications web site,

FIG. 3 illustrates an embodiment of a graphical user interface according to the present invention,

FIG. 4 to 8 illustrate further embodiments according to the present invention each including a telecommunications web site,

FIGS. 9 and 10 illustrate embodiments of embodiments according to the present invention for several information service providers and groups/categories of information service providers, respectively.

### DESCRIPTION OF PREFERRED EMBODIMENTS

End user units as used herein relate to any device, unit or means, which can be used for communications. Preferred end user units comprise stationary and mobile telephones (e.g. PSTN telephones, 2G and 3G devices, GSM and UMTS telephones), stationary and mobile computer systems, devices and units, telex systems, devices and units, etc.

The end user unit of the present invention is not limited to a particular communications unit/device or any communications network. Rather, communications by means of an end user unit can occur via any communications network such as regular telephone networks, mobile communications networks, computer networks, radio transmission networks, the Internet, etc. Further, an end user unit is not restricted to single devices or means, but can also include two and more units, devices, means and the like providing data/information sending and/or receiving capabilities for communications purposes, e.g., an ordinary letter and a scanner.

The end user unit is adapted to perform network-based communications. Thus, the end user unit is connectable to a network or rather able to communicate with a network. A network in this context is a physical transport medium in which data and/or signals can be fed. For example, an ordinary letter itself is adapted to perform network-based communication when scanned or digitized and supplied into a TCP/IP network.

A communications environment is a communications system comprising more than one component. Thus, a communications environment or communications system might for instance comprise a telephone, a PSTN-network, a gateway to the Internet, etc.

The terms “web site” and “web page” as used herein refer to sites and sub-sites associated thereto which can be uniquely addressed by means of a single address, like a telephone number or an IP address, an URL, etc. It is also advantageous to use such a “web site” in a 2G- and/or 3G-communication environment, especially a GSM- and/or UMTS-environment. Preferably, such a web site is a site known from the Internet with a specific URL, which can be accessed by Internet visitors, and by the web site host. The web site host is the owner of the web site.

This web site can include one or more web pages. These web pages are part of the one web site. It should be noted that the terms “web site” and “web page” are not to be considered to limit the present invention to conventional web sites and webpages known from the Internet. Thus, the web site and its web page(s), respectively, can be accessed by establishing a communications link from an end user unit independently of the network(s) employed.

In particular, a telecommunications web site is adapted to provide, upon an access by an end user unit, for direct private communications between the accessing end user unit and an end user unit to which a communications link is to be established.

A telecommunications web site is assigned to or personalized for or corresponding to a specific person or entity. Such a specific entity can be a person, a company or any other entity. Preferably, the specific entity is a single entity, e.g., a specific user or owner (e.g., a single person, a company, a unit of a company, etc.) of the telecommunications web site, a specific address, a specific location, a specific end user unit and the like. Thus, an end user unit of a user to whom a telecommunications web site is associated to will be also associated with that telecommunications web site if used for accessing the same.

A telecommunications web site serves as a general purpose communications interface for end user units and addressed entities, which can include or can be an end user unit itself. As an illustration, the telecommunications web site can be considered as a communications “window”, similar to a window of an office counter, where communicating parties are “sitting” on opposite sides of the window and can communicate through speech holes in the window, via an intercom, by gestures, by facial expressions, showing papers with information written thereon, passing documents through a hatch and so on. Comparable thereto, the telecommunications web site according to the present invention allows communications in a plurality of modes and by a plurality of types/formats of data/information.

An advantage of a telecommunications web site is that communications can be provided and established multimedial, i.e. using more than one medium. These different media can be used by using different end user units or different networks like for instance PSTN, IP-based networks or UMTS networks.

Properties and functions of a telecommunications web site, are described in commonly-assigned U.S. patent application Ser. No. 10/201446, entitled “Communications Environment,” filed Jul. 23, 2002, and in commonly-assigned U.S. patent application Ser. No. 10/354709, entitled “Web Site Having an Event Identification Element,” filed Jan. 29, 2003, both of which applications are hereby incorporated by reference herein.

In the following, it will be assumed that an entity comprises—as illustrative example of components, devices, apparatus, etc. of an entity—at least two end user units, for example a personal computer and a telephone.

Nevertheless, such a telecommunications web site can also be associated to an entity being different from an entity requesting an information service. In such a case, access to a telecommunications web site is, at least in that regard, not restricted to its owner, i.e. the entity the telecommunications web site is associate to. In such a case some modifications are contemplated, e.g. billing of cost for requesting and accessing an information service to an entity actually requesting and using an information service instead of the entity the telecommunications web site is associated to.

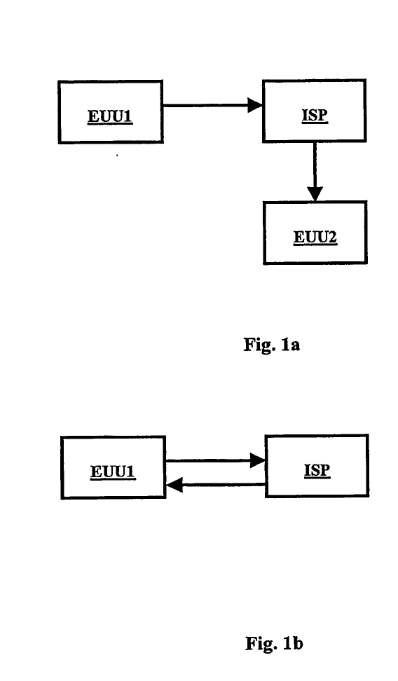

FIG. 1a illustrates an embodiment wherein a first end user unit EUU1 requests an information service. This can be accomplished, for example, by a user requesting an information service by means of a telephone or personal computer.

The first end user unit EUU1 communicates the request for an information service to an information service provider ISP via a request communications link. The request communications link to the information service provider ISP can accomplish by connecting to the information service provider ISP utilizing a so-called “#0800-service” in a telephone network providing telephone calls free of charge for the calling party.

The request can include data characterizing the information service provider ISP and, as an option, for security reasons, data identifying and/or authorizing the first end user unit EUU1 or its user, respectively, as a party for which an access of the information service provider ISP is allowed. Data suitable for security purposes include a so-called caller recognition of a user of the first end user unit EUU1 for example by means of PIN codes, TAN codes, voice recognition and/or other biometrical data recognition methods/devices, measures to identify the first end user unit EUU1 for example by means of a specific unit number or code and the like.

In response to the request, the information service provider ISP establishes an information service communications link via which the requested information service can be or has to be provided. It has to be noted that the information service communications link and the request communications link are different communications links, which allows to provide the information service requested by the first end user unit EUU1 to a second end user unit EUU2.

Providing the requested information service includes communicating the requested information service, e.g. in form of respective data, from the information service provider ISP to the second end user unit EUU2 and/or accessing the information service provider ISP by means of the second end user unit EUU2 to obtain the requested information service.

The second end user unit EUU2 to which of the request information service will be provided can be selected or specified in numerous ways.

For example, the information service provider ISP can have access, e.g. via a database of/for the information service provider ISP, to data associated to the first end user unit EUU1 indicating to which second end user unit EUU2 a requested information service can be provided. In case such data indicate more than one end user unit to which a requested information service can be provided, the information service provider ISP can select an user unit as second end user unit EUU2, for example, on the basis of a priority list, availability of indicated end user units (i.e. which of the indicated end user units is active at least for receiving an information service) and/or the nature of the requested information service in view of properties of indicated end user units (e.g. providing of voice data to a telephone; providing video data to television receiver or computer monitor; providing audio data to a radio receiver or computer audio system; providing software programs to a personal computer; providing telephone and/or address information to a personal address book of a mobile telephone, mobile or stationary computer, etc.).

Further, the request communicated from the first end user unit EUU1 to the information service provider ISP can include data directly characterizing and/or identifying the second end user unit EUU2.

Is also possible that the request communicated from the first end user unit EUU1 to the information service provider ISP includes data characterizing properties desired for communications link(s) to be established to the second end user unit EUU2. For example, such data can indicate a desired network (e.g. telephone/computer network of a specific provider), technical properties of the desired communications link (data rate, communications link cost, communications link related services, etc.) and the like.

Above data for specifying and/or indicating the second end user unit EUU2 can be communicated to the information service provider ISP prior to and separated from data in the request indicating the desired information service.

For illustrative purposes, operation of the embodiment shown in FIG. 1a will be described under the assumptions that the first end user unit EUU1 is a mobile telephone, that the information service provider ISP provides telephone numbers (possibly including respective postal addresses, email addressed, etc.), e.g. in form of a call center, and that the second end user unit EUU2 is a personal computer which is specified by respective data in the request communicated to the information service provider ISP as end user unit to which the requested information service is to be provided:

The user of the mobile telephone EUU1 needs a telephone number of a person and contacts the telephone number call center ISP. Usually, the requested telephone number will be returned to the mobile telephone EUU1 as voice message. This can represent a problem, because the user of the mobile telephone EUU1 is required to remember the telephone number, to write it down or to store the voice message in the mobile telephone EUU1. Such a troublesome effort for the user is particularly undesired in case the user intends to use the requested telephone number later.

Such problems can be resolved by the present invention because the user of the mobile telephone EUU1 can obtain the requested telephone number by means of a suitable, desired, preferred etc. end user unit. In particular, the telephone number call center ISP receives—together with the telephone number request—data characterizing the personal computer EUU2 to which the requested telephone number is to be communicated.

Then, the telephone number call center ISP communicates the requested telephone number to the specified personal computer EUU2, e.g. in form of a conventional voice message or, also enabled by the present invention, alphanumerical data. Having received the requested telephone number, the personal computer EUU2 can easily store that telephone number, advantageously in an automatic, software controlled manner, e.g. as voice file, text file, or address book entry.

The embodiment illustrated in FIG. 1b is comparable with the embodiment of FIG. 1a, in particular as a requested information service is provided via an information service communications link being different from a request communications link via which information service is request, except that in the embodiment illustrated in FIG. 1b the request information service is provided to the first end user unit EUU1.

For illustrative purposes, operation of the embodiment shown in FIG. 1b will be described under the assumptions that the first end user unit EUU1 is a mobile telephone and that the information service provider ISP provides telephone numbers (possibly including respective postal addresses, email addressed, etc.), e.g. in form of a call center:

Via a telephone communications link from the mobile telephone EUU1 to the telephone number call center ISP, a user of the mobile telephone EUU1 request a telephone number of a person.

Usually, the requested telephone number will be returned to the mobile telephone EUU1 as voice message. This can represent a problem, because the user of the mobile telephone EUU1 is required to remember the telephone number, to write it down or to store the voice message in the mobile telephone EUU1. Such a troublesome effort for the user is particularly undesired in case the user intends to use the requested telephone number later.

Such problems can be resolved by the present invention because the user of the mobile telephone EUU1 can obtain the requested telephone number by means of a suitable, desired, preferred etc. end user unit. In particular, the telephone number call center ISP receives—together with the telephone number request—data characterizing that the requested telephone number is to be communicated to the mobile telephone EUU1 as e.g. SMS; i.e. via a communications link being different to the telephone communications via which the telephone number request was communicated.

Then, the telephone number call center ISP communicates the requested telephone number to the mobile telephone EUU1, here in form of a SMS. Having received the requested telephone number, the mobile telephone EUU1 can easily store that telephone number, advantageously in an automatic, software controlled manner, e.g. as text file, or address book entry.

In the following, for the sake of simplicity only, further embodiments are described such that an end user unit is used for requesting an information service, while another end user unit will be provided the requested information service. Nevertheless, all further embodiments can be implemented such that an end user unit requests—via one communications link—an information service and is provided—via another communications link—the requested information service.

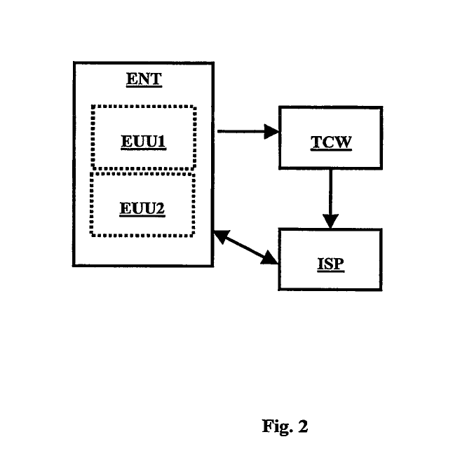

A more enhanced embodiment is illustrated in FIG. 2. Here, an entity ENT requests an information service from an information service provider ISP via a telecommunications web site TCW. The entity ENT comprises at least two end user units, an end user unit EUU1 for requesting an information service and at least one end user unit EUU2 to which the requested information service can be provided. For example, an information service can be requested by means of telephone of the entity ENT, while the requested information service can be provided to a personal computer of the entity ENT.

The entity ENT communicates, by means of the requesting end user unit EUU1, the request for an information service to a telecommunications web site TCW, preferably the telecommunications web site TCW the entity ENT is associated to.

For establishing a communications link to the telecommunications web site TCW, the telecommunications web site TCW is activated or “opened”. For example, this can accomplish by connecting to the telecommunications web site TCW utilizing a so-called “#0800-service” in a telephone network providing telephone calls free of charge for the calling party. Data for accessing the telecommunications web site TCW include data characterizing the telecommunications web site TCW and, as an option, for security reasons, data identifying and/or authorizing the entity ENT or its user, respectively, as a party for which an access of the telecommunications web site TCW is allowed.

Data suitable for security purposes include a so-called caller recognition of a user of the entity ENT for example by means of PIN codes, TAN codes, voice recognition and/or other biometrical data recognition methods/devices, measures to identify the entity ENT for example by means of a specific unit number or code and the like.

In response to the request, the telecommunications web site TCW contacts a respective information service provider ISP or selects at least one suitable information service provider ISP. Then, via an information service communications link between the information service provider ISP and the entity ENT, the requested information service can be provided to another, the receiving end user unit EUU2 of the entity ENT. Providing the requested information service includes communicating the requested information service, e.g. in form of respective data, from the information service provider ISP to the entity ENT and/or accessing the information service provider ISP by means of the entity ENT to obtain the requested information service.

The end user unit EUU2 of the entity ENT to which of the request information service will be provided can be selected or specified in numerous ways.

For example, the telecommunications web site TCW can have access, e.g. via a memory of/for the telecommunications web site TCW, to data associated to the entity ENT indicating to which end user unit thereof a requested information service can be provided. In case, such data indicate more than one end user unit to which a requested information service can be provided, the telecommunications web site TCW can select an user unit of the entity ENT as receiving end user unit, for example, on the basis of a priority list, availability of indicated end user units (i.e. which of the indicated end user units is active at least for receiving an information service) and/or the nature of the requested information service in view of properties of indicated end user units (e.g. providing of voice data to a telephone; providing video data to television receiver or computer monitor; providing audio data to a radio receiver or computer audio system; providing software programs to a personal computer; providing telephone and/or address information to a personal address book of a mobile telephone, mobile or stationary computer, etc.).

Further, the request communicated from the entity ENT to the telecommunications web site TCW can include data characterizing and/or identifying an end user unit of the entity ENT as receiving end user unit.

Is also possible that the request communicated from the entity ENT to the telecommunications web site TCW includes data characterizing properties desired for communications link(s) to be established to the entity ENT for providing the requested information service. For example, such data can indicate a desired network (e.g. telephone/computer network of a specific provider), technical properties of the desired communications link (data rate, communications link cost, communications link related services, etc.) and the like.

Above data for specifying and/or indicating a receiving end user unit of the entity ENT can be communicated to the telecommunications web site TCW prior to and separated from data in the request indicating a desired information service.

For establishing an information service communications link, the telecommunications web site TCW can use information identifying/characterizing the information service desired/requested by the entity ENT. Such information can be provided by the entity ENT to identify:
a specific information service,
a group of information services,
a category of one or more information services,
a specific company, firm, and the like which offer products and/or services for which information in form of a information service is desired/requested,
a group of companies, firms, and the like which offer products and/or services for which information in form of a information service is desired/requested,
a category of one or more companies, firms, and the like which offer products and/or services for which information in form of a information service is desired/requested,
a specific product and/or service for which information in form of an information service is desired/requested,
a group of products and/or services for which information in form of an information service is desired/requested,
a category of one or more products and/or services for which information in form of an information service is desired/requested.

For indicating a specific information service, a telephone number, an URL and the like of a respective information service provider or the name of an information service provider can be communicated. In the latter case, the telecommunications web site TCW can, for example, retrieve a telephone number or URL of an indicated information service provider from a respective data set personalized for the entity ENT or from a public telephone book or URL register.

For indicating a group or category of information services or companies or products/services, one or more keywords can be communicated. Then, the telecommunications web site TCW can search (utilizing, e.g., data basis, network based search engines etc.) one or more information service providers, which will provide information for the indicated group or category and/or from which such information can be expected. Having specified one or more of such information service providers, the telecommunications web site TCW obtains, if not already available from the search process, information necessary to establish an information service communications link. Suitable information includes a telephone number or URL of an identified information service provider.

The telecommunications web site TCW can select a suitable and/or desired communications environment or network for establishing at least parts of a information service communications link. For selecting a suitable communications environment or network, the telecommunications web site TCW can select an appropriate one in view of least-cost-routing, prevailing utilization, data rates, bandwidths, reliability, security and the like. For a desired communications environment or network, the telecommunications web site TCW can select an appropriate one in view of information provided by the entity ENT (e.g. “establish a PSTN telephone network communications link” or “establish an internet communications link”), the type of device used as receiving end user unit of the entity ENT (e.g. personal computer, stationary telephone, mobile telephone), contracts with the communications environment or network provider or services for the entity ENT, the type of indicated information service (e.g. information including audio and/or graphical data, voice messages, printed information) and the like.

In general, operation of the embodiment illustrated in FIG. 2 comparable to the information of the embodiment illustrated in FIG. 1 but provides further capabilities as described below.

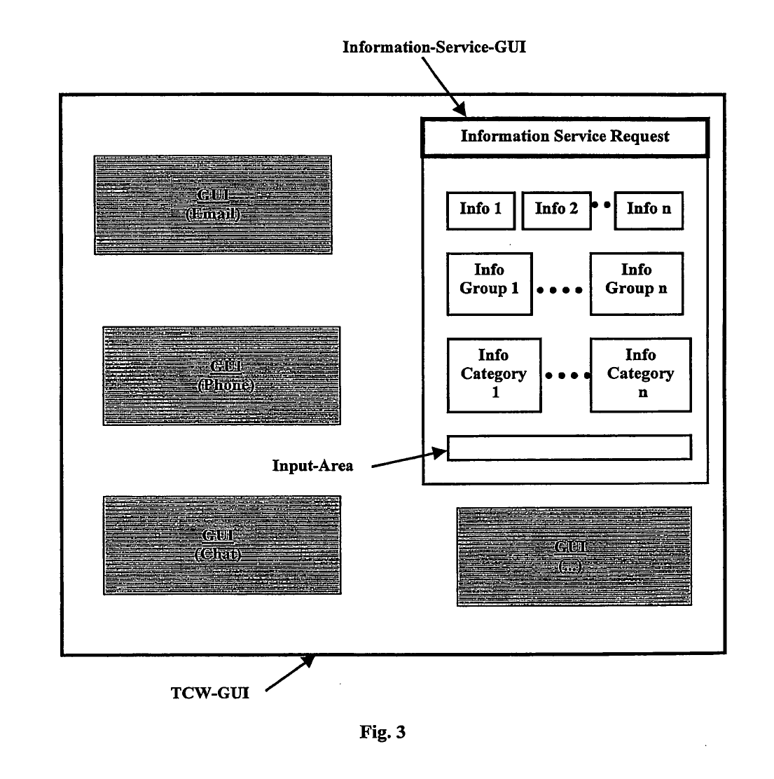

For employing the telecommunications web site TCW to request an information service, the telecommunications web site TCW can provide a graphical user interface an example of which being illustrated in FIG. 3. As shown, the telecommunications web site TCW provides a graphical user interface “TCW-GUI” comprising different graphical user interfaces for different uses of the telecommunications web site TCW, such as E-mail applications “GUI (email)”, telephone services “GUI (phone)”, chat communications “GUI (chat)” and the like “GUI ( . . . )”.

For requesting an information service via the telecommunications web site TCW, an information service graphical user interface “Information-Service-GUI” is provided, which comprises several options for an user. For example, by means of graphical user interfaces “Info 1”, . . . , “Info n”, predefined specific information services can be requested by operating one of these interactive areas of the graphical user interface “Information-Service-GUI”.

In order to request groups and categories of information services, information service providers, companies, firms, products, services and the like, graphical user interfaces “Info Group 1”, . . . , “Info Group n” and “Info Category 1”, . . . , “Info Category n” are contemplated.

These graphical user interfaces can be, e.g., activated by using a pointing device (“mouse”) or voice-controlled means. An area “Input-Area” is provided in the graphical user interface “Information-Service-GUI” wherein a user can input a name, telephone number, URL, address and the like for requesting further information services, in particular information services not covered by the above graphical user interfaces.

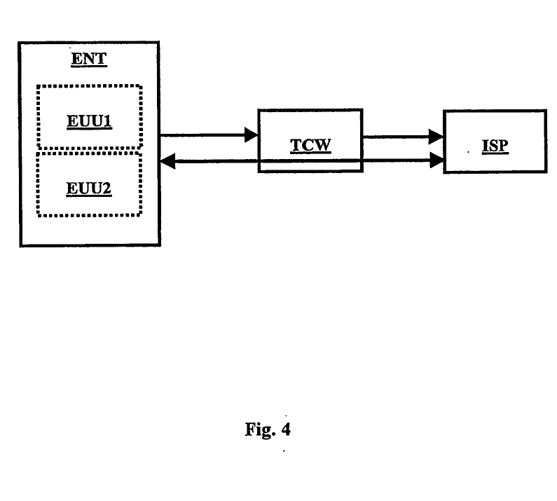

As illustrated in FIG. 4, the information service communications link can be established directly via the telecommunications web site TCW. Here, it is possible that the telecommunications web site TCW is also provided, at least partially, the requested information service, for example, to store at least parts of a data included in the requested information service for later access or retrieval by the entity ENT. Referring to the above for example of a request for a telephone number, the telecommunications web site TCW can store the requested telephone number in an address/telephone book associated to the entity ENT. Then, the entity ENT can access to the requested telephone number by accessing its telecommunications web site TCW.

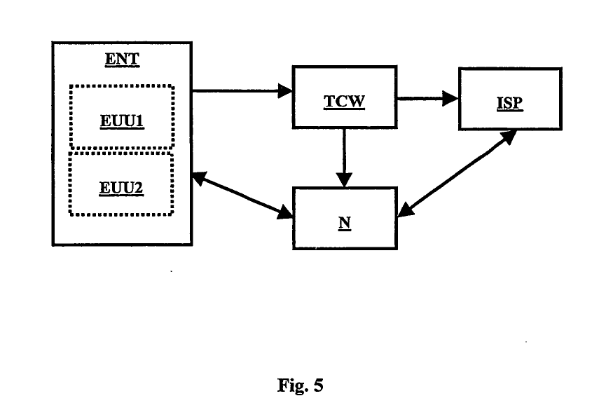

Further, as shown in FIG. 5, the information service communications link can be established such that the telecommunications web site TCW does not form a part of the information service communications link. This accommodates for an information service provider ISP which provides its information service, e.g., via a communications environment being different with respect to the communications environment used for communications between the entity ENT and the telecommunications web site TCW and/or between the telecommunications web site TCW and the information service provider ISP. For example, this embodiment allows establishing the information service communications link in a telephone communications environment, a special computer network, a radio and/or television broadcast network etc.

Referring to FIG. 5, it is assumed that a PSTN network or mobile telephone network based communications link is to be established as information service communications link. After the information service provider ISP is selected, the telecommunications web site TCW contacts a communications link unit N such as a PSTN switching or a radio base station to initiate two telephone calls originating from that communications link unit N: one as communications link to the entity ENT and one as communications link to the information service provider ISP.

For establishing a communications link actually serving as information service communications link, it is possible that the communications link unit N merges the two communications links to the entity ENT and to the information service provider ISP. In the case of telephone communications links, this can be accomplished comparable to conference call. Such a communications link establishment can be formed by the communications link unit N by itself, for example on the basis of a respective data provided by the telecommunications web site TCW indicating that the communications links outgoing from the communications link unit N to the entity ENT and the information service provider ISP should be connected to provide for the information service communications link.

Further, to actually establish an information service communications link between the entity ENT and the information service provider ISP, it is possible that the two separate communications links originating from the communications link unit N to the entity ENT and the information service provider ISP are connected via the telecommunications web site TCW and/or under control of the telecommunications web site TCW.

Independently of how an information service communications link to the entity ENT is actually established, measures for charging costs related to the establishing and using of an information service communications link to the entity ENT as well as charging cost related to an access to the such information service provided are contemplated.

In case an information service communications link is established directly via the telecommunications web site TCW, billing of communications link related costs will be accomplished by the telecommunications web site TCW. Information service related cost could also be accounted by means of the telecommunications web site TCW, for example, using respective information from the information service provider ISP.

In case an information service communications link is established via the communications link unit N, billing of communications link related costs can also accomplished by the telecommunications web site TCW using respective information from the communications link unit N. Nevertheless, communications link related cost could also be charged directly from the communications link unit N to the entity ENT. Information service related cost can also be accounted by means of the telecommunications web site TCW, for example, using respective information from the information service provider ISP received directly from the information service provider ISP or via the communications link unit N. Further, information service related cost can also be charged from the communications link unit N to entity ENT, for example, using respective information from the information service provider ISP.

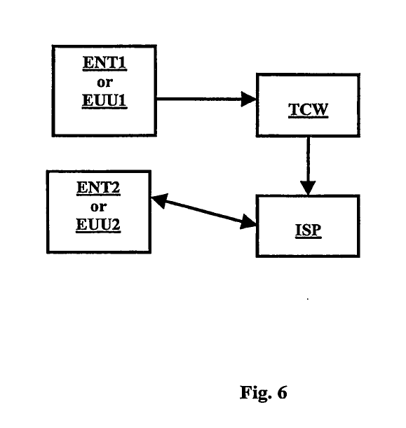

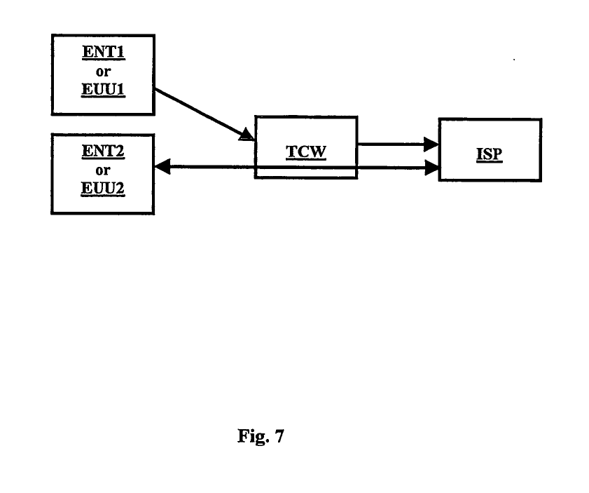

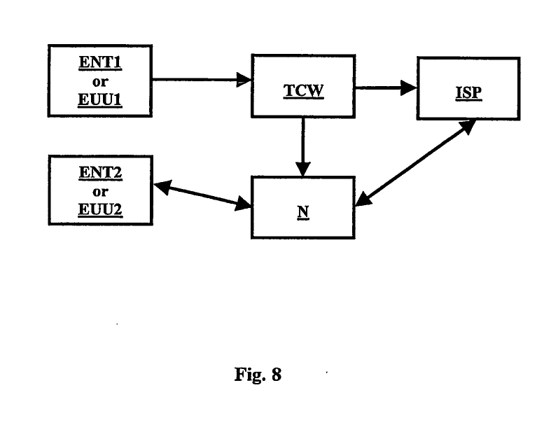

Further, as illustrated in FIG. 6 to 8, it is possible that an information service is requested by a first entity ENT1 or a first end user unit EUU1 via a telecommunications web site TCW, while the requested information service is provided to a second entity ENT2 or a second end user unit EUU2. The explanations given above with respect to FIG. 2 to 5 also apply to the embodiments shown in FIG. 6 to 8 except for the establishment of the information service communications link to the second entity ENT2 or the second end user unit EUU2. A further difference can be the way in which costs related to the establishment and use of an information service communications link and/or cost related to the providing/accessing of an information service are charged. While in the preceding embodiments cost are accounted to the entity ENT as integral billing unit, in these embodiments the charging of cost can be performed to each entity separately, here, on the one hand, to the first entity ENT1 or first end user unit EUU1 and, on the other hand, to the second entity ENT2 or second end user unit EUU2.

As described above, the information service indicating data can indicate a specific information service, a specific company, firm, and the like which offers products and/or services for which information in form of a information service is desired/requested, a specific product and/or service for which information in form of a information service is desired/requested etc. Such cases are illustrated in FIGS. 1, 2 and 4 to 8 by means of a single information service provider ISP which can correspond to the specific information service, the specific company, firm, and the like which offers products and/or services for which information in form of a information service is desired/requested, a information service provider for the specific product and/or service for which information in form of a information service is desired/requested etc.

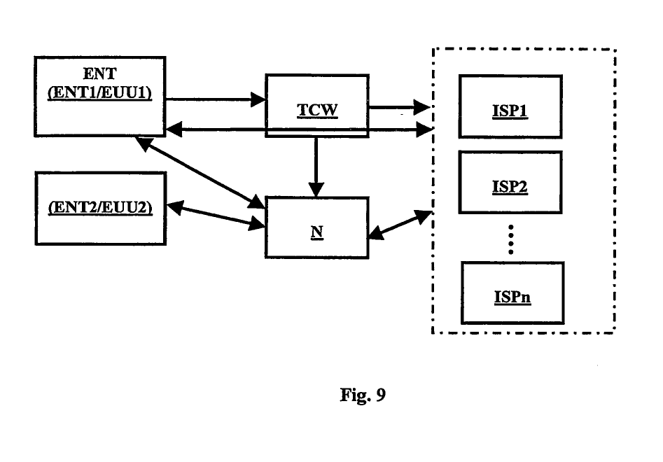

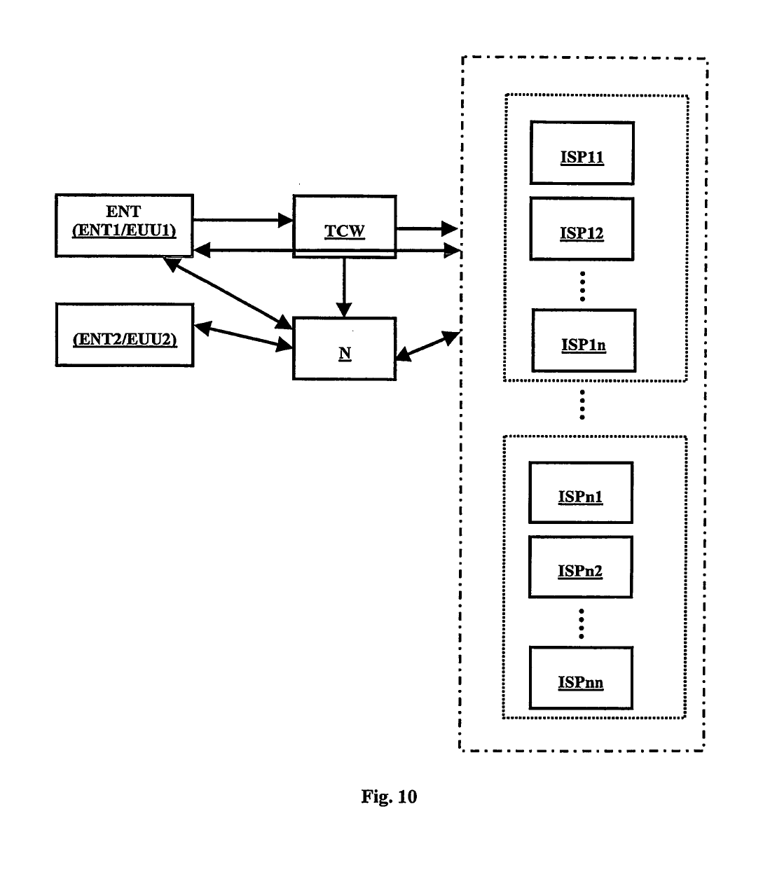

Further, the information service indicating data can indicate a group of information services, a category of one or more information services, groups/categories of companies, firms, and the like which offer products and/or services for which information in form of a information service is desired/requested, groups and/or categories of products and/or services for which information in form of a information service is desired/requested etc. Such cases are illustrated in FIG. 9 and 10.

FIG. 9 illustrates information service providers ISP1, . . . , ISPn forming, a group of information service providers or belonging to a category of information service providers. FIG. 10 illustrates information service providers ISP11, . . . , ISP1n and information service providers ISP21, . . . , ISPnn forming, 2 to n groups of information service providers or belonging to 2 to n categories of information service providers.

The explanations given above with respect to FIG. 2 to 8 also apply to the embodiments shown in FIGS. 9 and 10 except for the establishment of the information service communications link to an information service provider ISP. In these embodiments, before establishing a information service communications link to an information service provider ISP, the telecommunications web site TCW can select at least one appropriate information service provider ISP. As an option or in addition thereto, such a selection of an information service provider ISP, can also be performed by an entity. In the latter case, it is contemplated that the telecommunications web site TCW communicates information to an entity indicating suitable and available information service providers ISPs on the basis of which the receiving entity or its user, respectively, can select one or more information service provider ISP from the available information service providers ISPs.

Further, it is possible that more than one information service provider ISP is selected to each of which a information service communications link will be established. Here, information service communications links to different information service providers ISPs can be established subsequently and/or at the same time.

Although above embodiments have been described separately, it is contemplated that features described for specific embodiments can be integrated in different embodiments, i.e. any feature of any embodiment can be implemented in any different embodiment.

1-19. (canceled)

20. A method for providing an information service, comprising the steps of: communicating, via a request communications link to at least one information service provider (ISP), information service indication data indicating at least one information service requested by a user, and providing the at least one indicated information service from at least one of the at least one information service provider (ISP) via an information service communications link to the user.
